(19) United States
(12) Patent Application Publication
(10) Pub. No.: US 2026/0310934 A1
(43) Pub. Date: Oct. 8, 2026

(54) MULTI-AGENT ARTIFICIAL INTELLIGENCE DEADLOCK DETECTION AND RESOLUTION

(71) Applicant: Edwin Barton Yeary, Orinda, CA (US)

(72) Inventor: Edwin Barton Yeary, Orinda, CA (US)

(21) Appl. No.: 19/456,964

(22) Filed: Jan. 22, 2026

Related U.S. Application Data
(63) Continuation-in-part of application No. 19/294,935, filed on Aug. 8, 2025.
(60) Provisional application No. 63/783,952, filed on Apr. 5, 2025.

(51) Int. Cl. G06N 3/045

(52) U.S. Cl. CPC G06N 3/045

(57) ABSTRACT

A computing device includes a processor and memory storing instructions to detect deadlock among artificial intelligence (AI) agents and resolve it using a counter-AI agent. The device processes input data with multiple AI agents, each operating under a respective constraint, and determines whether differences among their outputs satisfy a deadlock condition. In response to detecting deadlock, the device initializes a counter-AI agent configured with a counter-constraint different from at least one agent's constraint. The counter-AI agent processes the input to generate an indication for modifying the AI ensemble. At least one agent is modified, and the input is reprocessed to produce updated outputs. The device synthesizes the updated outputs into a final output, improving convergence and adaptability.

### CROSS-REFERENCE TO RELATED APPLICATIONS

This application is a continuation in part of U.S. patent application Ser. No. 19/294,935, filed on Aug. 8, 2025, which claims priority to U.S. Provisional patent application 63/783,952 filed on Apr. 5, 2025. The contents of both applications are incorporated by reference in their entirety.

### TECHNICAL FIELD

The present disclosure relates to artificial intelligence (AI) and machine learning (ML), and more specifically, to enhanced deadlock handling, memory management, performance, and accuracy in an agentic AI system.

### BACKGROUND

AI and ML technology typically refers to computers that have been programmed and/or taught to process data in a manner that resembles human intelligence. Generally, these computers process data, spot patterns, make predictions, and solve problems without being explicitly programmed for every possible scenario. The field continues to grow. AI systems can translate languages, diagnose medical conditions, drive cars, and create written or visual works.

### SUMMARY

In an aspect of the present disclosure, a computing device is configured to perform operations comprising: processing input data with a plurality of artificial intelligence (AI) agents, each configured to operate under a respective constraint set, to obtain a plurality of first outputs; verifying that a difference between the plurality of first outputs satisfies a deadlock condition; initializing a counter-AI agent in response to the deadlock condition being satisfied, wherein the counter-AI agent operates under a counter-constraint set different from the respective constraint set of at least one of the plurality of agents; processing the input data with the counter-AI agent to obtain a second output comprising an indication to modify the plurality of AI agents; modifying at least one of the plurality of AI agents in accordance with the indication; reprocessing the input data with the plurality of AI agents, including the modified agent, to obtain updated first outputs; and synthesizing the updated first outputs to generate a final output.

In an embodiment, verifying that the difference between the plurality of first outputs satisfies the deadlock condition comprises comparing the plurality of first outputs to each other to determine that the difference is less than a similarity threshold.

In an embodiment, the similarity threshold defines at least one of: an embedding similarity threshold, a tonal vector similarity threshold, or a similarity in memory reliance.

In an embodiment, verifying that the difference between the plurality of first outputs satisfies the deadlock condition comprises comparing the plurality of first outputs to each other to determine that the difference is greater than a difference threshold.

In an embodiment, the difference threshold defines at least one of: an embedding difference threshold, a tonal vector difference threshold, a divergence in memory reliance, a domain inconsistency, or a mutually exclusive reasoning trace.

In an embodiment, modifying at least one of the plurality of AI agents in accordance with the indication comprises modifying a retrieval scope, an evidence window, an inference configuration, or the respective constraint set of the AI agent.

In an embodiment, the counter-AI agent operates under an expanded search space relative to one or more of the plurality of AI agents.

In an embodiment, the counter-AI agent is instantiated with a time-to-live (TTL), the TTL corresponds with an arbitration period of generating the final output, and the counter-AI agent is released upon expiration of the TTL.

In an embodiment, the counter-constraint set is generated based on inverting, broadening, or narrowing the respective constraint set of at least one of the plurality of AI agents.

In an embodiment, synthesizing the plurality of updated first outputs to generate the final output comprises performing a weighted combination of the updated first outputs.

In an embodiment, initializing the counter-AI agent comprises instantiating a new counter-AI agent.

In an embodiment, the counter-AI agent is an internal neuro pathway of one of the plurality of AI agents, and the counter-constraint set is assigned to the internal neuro pathway.

Aspects described include one or more methods and/or workflows, which may be performed by a computer system, or stored as instructions in a non-transitory computer readable medium.

### TERMS AND DEFINITIONS

Agent: An autonomous artificial intelligence (AI) entity configured to perform tasks, generate outputs, or collaborate with other agents in accordance with a behavioral role and control layer. An agent may comprise a machine learning model, trained to process input data to generate an output.
Control Layer: A modular construct defining an agent's role, hierarchical constraints, tone vector, privilege levels, and evolution or escalation logic. The behavioral control layer governs agent behavior during inference.
Constraint: A rule that may be assigned to govern runtime operation of an agent, which may be enforced to influence operation or output (e.g., an action) of an agent.
Constraint Stack: A set of behavioral constraints applied to an agent, the constraints enforced according to global, domain-specific, and situational precedence. Constraint stack and constraint set may be used interchangeably in the present disclosure.
Constraint-Embedded Memory: A memory structure that retains constraint data, tone settings, and privilege levels across interactions to ensure continuity of behavioral governance.
Influence Weighting Model: A governance mechanism that applies and adjusts weights to domain vectors, tone sensitivity profiles, and constraint sensitivity levels, modulating agent and ensemble behavior.
Temporary Control Layer: A temporary constraint injected into an agent's behavioral control layer during runtime to address specific compliance requirements, the temporary control layer having precedence over existing constraints until expiration.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 shows a computer system that controls the behavior of one or more agents through a control layer, in accordance with some embodiments.

FIG. 2 depicts a computer system for detecting and resolving AI agent deadlock, in accordance with some embodiments.

FIG. 3 shows an example workflow for performing AI agent ensemble deadlock detection, in accordance with some embodiments.

FIG. 4 illustrates a workflow of a system configured to resolve deadlock among a plurality of artificial intelligence agents by generating and applying structured divergence, in accordance with some embodiments.

FIG. 5 illustrates a flow diagram of a system configured to perform arbitration and synthesis of outputs from a multi-agent ensemble following deadlock resolution, in accordance with some embodiments.

FIG. 6 illustrates a workflow to manage the lifecycle of a counter-AI agent instantiated during deadlock resolution.

FIG. 7 illustrates a flow diagram of a system configured to perform tone and domain arbitration during synthesis of a governed final output.

FIG. 8 illustrates a flow diagram of a system configured to perform memory-conditioned arbitration during synthesis of a governed final output.

FIG. 9 shows an example method for detecting and resolving a deadlock in a plurality of AI agents, in accordance with some embodiments.

FIG. 10 is one embodiment of a computer system that may be used to support the systems and operations described, in accordance with an embodiment.

### DETAILED DESCRIPTION

Agentic AI refers to artificial intelligence that is configured to operate with a degree of autonomy to achieve goals through decision-making and action-taking, as opposed to simply responding to prompts or performing a strict input/output operation. Agentic AI can make decisions and take actions without constant human direction, operating based on their programming and learned behaviors. Agents work toward specific objectives, whether explicitly programmed or learned through training. They can perceive their environment (digital or physical) and act within it. Actions may include accessing databases, calling APIs to interact with websites or other applications, generating control commands to operate and control machinery or robots, interacting with humans, displaying or processing data, or organizing memory, to name a few. Agents are configured to evaluate situations and choose from multiple possible actions based on their understanding of the current state and desired outcomes. Unlike single-interaction AI systems, agents can be configured to operate continuously over time, maintaining state and context over time and/or over multiple actions.

Existing agentic systems lack reliable mechanisms to detect and resolve ensemble deadlocks. Such deadlocks may arise from premature convergence or unstructured contradiction. These systems do not detect when multiple agents are converging too narrowly on the same context or relying on correlated evidence slices, nor can they consistently diagnose mutually exclusive reasoning traces or domain inconsistencies across agents. As a result, they provide limited support for introducing a principled counter-perspective, updating ensemble operating conditions in a controlled manner, and producing a final result, much less doing so in a traceable manner.

Aspects of the present disclosure relates to a computing system that address deficiencies of existing systems such as those noted above, by processing input data with an original ensemble of agents, each operating under a respective constraint set, verifying a deadlock condition using similarity-based and/or divergence-based analysis, instantiating a counter-agent under a counter-constraint set that differs from at least one original constraint set to generate a structured counter-perspective, and using that counter-agent's output to guide modification to the ensemble. In some embodiments, the guided updates performed by the system can include expanding what data is considered for inference, adjusting runtime generation settings and pathways, and/or temporarily tuning applicable constraints. The system can reprocess the input with the modified ensemble to obtain updated outputs and synthesize those updated outputs into a final output, thus resolving potential deadlocks in a multi-agent system. Other embodiments are described.

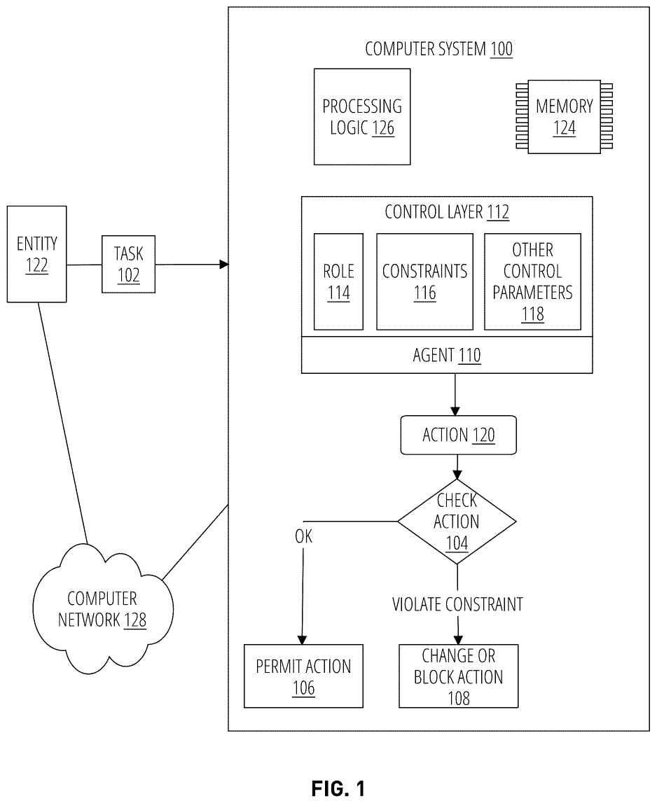

FIG. 1 shows a computer system that controls the behavior of one or more autonomous agents through a control layer, in accordance with some embodiments.

The computer system 100 includes memory 124, and processing logic 126. Processing logic 126 may comprise one or more processors such as, for example, one or more central processing units (CPUs), and/or one or more graphics processing units (GPUs), and/or other processing devices. Processing logic may include an application, an operating system, a service, a subroutine, embedded instructions or a script, an agent that is governed by a control layer, or a combination thereof. It should be understood that actions described as being performed by processing logic or a computer system throughout the present disclosure, may be interpreted as being performed by the agent, or a service or routine executing separate from the agent, or a combination thereof. Computer system 100 comprises memory 124, which may comprise random access memory (RAM), video RAM (VRAM), cache, disk, solid state drives (SSD), hard disk drives (HHD), or other computer-readable memory. The computer system 100 may be connected to a computer network 128. Computer network 128 may include a collection of interconnected computing devices that can communicate and share resources, such as files, applications, printers, and internet access. Network devices such as routers and switches direct network traffic between different networks, or manage traffic within a single network. Network nodes such as computers, servers, smartphones, and other hardware, are connected via communication links like cables, Wi-Fi, or satellite connections. Computer system 100 may represent a plurality of computer nodes and/or services (e.g., in a microservices application) which may be distributed over the computer network 128 on separate devices, configured to work together to perform the described operations.

Computer system 100 is configured to instantiate a control layer 112 in memory 124, and attach the control layer 112 to an agent 110. In some embodiments, computer system 100 may load agent 110 to memory 124, where the agent 110 is ready for handling tasks. Prior to instantiation, a control layer may comprise a class (e.g., a plain old Java object (POJO)), or other machine instantiable data structure, which may include placeholders for control layer parameters which are initiated upon instantiation. The control layer may comprise an application programming interface (API) or other interface that allows the computer system 100, an agent, and/or other services operating in the computer system 100 to communicate with the agent and/or extract parameters from that agent (e.g., role, constraints, etc.).

The control layer 112 may comprise at least a role 114, and constraints 116. The role 114 defines the role of agent 110, such as its functional identity and/or domain of operation. The constraints 116 may comprise one or more constraints, or a plurality of constraints 116.

In some embodiments, computer system 100 forms the constraints 116 as a constraint stack or a hierarchical constraint stack. A hierarchical constraint stack may be constructed as a data structure with elements (e.g., constraints) stored in a tree data structure with parent-child relationships. This means that some constraints serve as parents to others, and this pattern is repeated throughout the structure. By constructing the constraints as a hierarchical stack, processing logic allows for efficient storage, retrieval, and implementation of constraints, while using a natural hierarchical or nested structure that is complementary in defining roles for agents

The constraints 116 define the permissible actions of the agent 110 to which the control layer 112 is attached to. Additional control parameters 118 may be included in the control layer 112 to further modulate agent behavior, such as tone, privilege levels, or escalation logic, as described in other sections.

The computer system 100 may receive a task 102 from an entity 122. The entity 122 may represents an external or internal actor (such as a user, administrator, or another system component) that may interact with the computer system 100 and initiate tasks. In some examples, the computer system 100 and the entity 122 may be one and the same, for example, the computer system 100 may generate one or more tasks to simulate operation of the agent 110 and other system components, as described in other sections. In other examples, the entity 122 may comprise a service, a subroutine, an application, a network node, or other entity that is separate from the computer system 100.

A task 102 is an assignment or objective received by the computer system 100 that requires execution by an agent 110. Tasks 102 can vary widely depending on the domain and the agent's role 114. For example, a task 102 may include generating a summary of data for a client, drafting an email update for a team, generating a control command for operational technology (OT), arranging travel accommodations, processing physical sensor data, determining a vehicle driving route or vehicle actuator commands, or reviewing a document for compliance. Each task may represent a distinct operation or set of operations, with a target outcome, that the system may assign to one or more agents to perform.

The computer system 100 may select agent 110 based on role alignment with task 102. For example, upon receiving a task 102, the computer system 100 evaluates the available agents, which may include those that are already loaded in memory 124, and selects agent 110 for task execution based on the agent's role 114 and its alignment with one or more characteristics of the task 102. For example, if the task 102 is to generate vehicle control commands, and role 114 indicates a corresponding role intended to generate vehicle control commands, computer system 100 selects the agent 110 with attached control layer 112 for the task 102.

The computer system 100 may direct the agent 110 (e.g., through signaling, an application programming interface (API), or other communication means) to process and perform the task 102.

As the agent 110 proceeds to process the task 102 (e.g., as input to the agent's underlying ML model) each proposed action 120 generated by the agent 110 is evaluated by the computer system 100 against the control layer 112 at block 104. It should be understood that the agent itself can be configured to perform the evaluation of its action against the control layer 112, or this functionality may be performed by the larger computer system 100 and one or more services thereof, or a combination thereof.

At block 104, the computer system 100 determines whether the action 120 satisfies all applicable constraints 116 in the constraint stack. If the action 120 is found to violate one or more of the constraints 116, the computer system 100 may block the action 120 or modify the action 120 to ensure compliance before execution. For example, action 120 may include an attempt to execute a structured query to retrieve data from a database as part of a data mining operation. Other examples of action 120 might include sending a network request to a remote system to claim an object or resource, annotate a digital document, generate an audio signal, or determine a network resource to use in a telecommunication operation.

Each action 120 is evaluated against the control layer 112 (e.g., against the constraints 116, role 114, and/or other control parameters 118) to check that the action 120 satisfies the relevant constraints 116. If the action 120 satisfies the constraints 116 and/or other parameters of the control layer 112, then computer system 100 proceeds to block 106 and permits the agent 110 to perform the action 120.

In response to determining that the action 120 does not satisfy the constraints 116 and/or the other control parameters 118, computer system 100 proceeds to block 108 to change or block the action 120. For example, computer system 100 may change the action 120 to refer to a different database or memory location that is permitted by constraints 116, or completely block the agent 110 from performing the action 120.

In some embodiments, computer system 100 may signal to the agent 110 to discontinue the action 120, or prevent an outbound signal from agent 110 from reaching its intended destination. The mechanism for blocking or changing action 120 may vary, depending on the task 102, the agent 110, and/or the action 120.

The computer system 100 works to ensure that every agent operates within a clearly defined role and set of constraints. This supports dynamic, context-aware task assignment and execution that aligns with efficient memory management and access, cybersecurity concerns, and other data policies. By evaluating and enforcing constraints in real time, blocking or modifying actions that do not comply, the system restricts the agent's actions in a controlled manner.

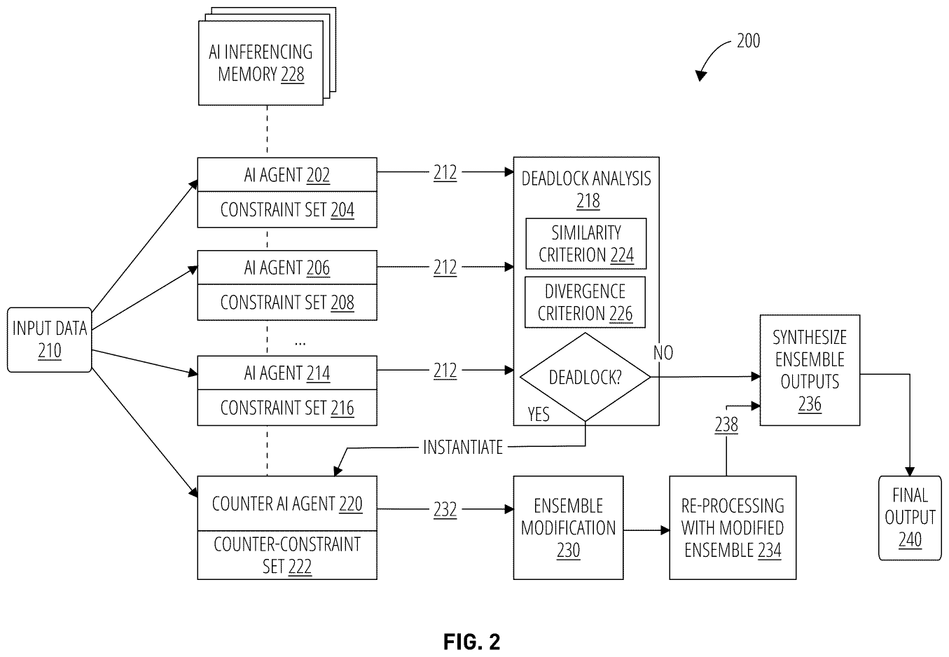

FIG. 2 depicts a computer system for detecting and resolving AI agent deadlock, in accordance with some embodiments. It should be understood that aspects described with respect to one figure may correspond to another, or share the same features. For example, the computer system 200 may share the same features as those described with respect to the computer system described with respect to FIG. 1, and vice versa. Additionally, it should be understood that aspects described in workflows and methods of the other figures may be and are performed by computer system 100 or computer system 200.

The computing device 200 obtains input data 210 and processes it with an original ensemble of AI agents (e.g., 202, 206, 214) to generate a plurality of first outputs 212. Input data 210 refers to any digitized information or signals provided to one or more AI agents for analysis, reasoning, generation, control, or decision-making, including raw, preprocessed, or derived data, and may be furnished continuously, in batches, or on demand. By way of non-limiting example, input data can include sensor data (e.g., LiDAR, radar, IMU), image or video data, audio streams, network traffic data and telemetry, logs and metrics, structured or unstructured text (including prompts, documents, and code), tabular and time-series records, geospatial coordinates and maps, database records, and other digital or physical-world signals, alone or in any multimodal combination.

As described, an AI agent is a software and hardware component configured to perceive inputs, reason about them, and take actions that align with a goal or task. An AI agent may include a machine learning model and a wrapper that provides the surrounding logic, tools, and decision-making framework that allow the model to operate in a structured way, such as interpreting user requests, orchestrating functions, or applying rules and constraints. The AI agent may be configured to perform planning, memory, and interaction, while relying on the underlying model as its core engine for understanding and generating information. A machine learning model may be understood as a computational system trained to recognize patterns in data and make predictions or generate outputs based on those patterns. Machine learning models may include various different algorithms. In an embodiment, a model may include one or more artificial neural networks. Generally, these networks are trained by adjusting the strength of connections between units during training, typically through repeated exposure to large datasets and the use of optimization algorithms that minimize errors.

Each of the original ensemble AI agents may comprise respective constraint sets. For example, AI agent 202 operates under constraint set 204, AI agent 206 operates under constraint set 208, and AI agent 214 operates under constraint set 216. Each agent is configured to operate under a respective constraint set that governs permissible actions, available AI inferencing memory, domain, output characteristics, or other constraints. In an embodiment, each set of constraints is associated with a control layer as described with respect to FIG. 1, and the control layer enforces runtime compliance while the agent generates its output. Further, although the constraint sets may have overlapping constraints, each of the AI agents may have a unique constraint set.

At deadlock analysis block 218, the computer system 200 evaluates whether a difference among the plurality of first outputs 212 satisfies a deadlock condition. The computer system 200 may compare the plurality of first outputs 212 to a similarity criterion 224 to detect a potential unwanted convergence by the AI agents. Additionally, or alternatively, the system may compare the plurality of first outputs 212 to a divergence criterion 226 to detect a potential contradiction among the AI agents. The computer system 200 can analyze the plurality of first outputs 212 through various benchmarks to compute the differences between them. For example, the computer system 200 can compute embedding-space similarity among the plurality of first outputs 212, measure tone-vector similarity to assess stylistic and role alignment, estimate output entropy to identify degenerate responses, and analyze memory reliance patterns indicating which regions of AI inferencing memory 228 each of the ensemble AI agents are relying upon to generate their output. For example, AI agent 214 may have relied on a first context slice or historical record in AI inferencing memory 228 to generate the corresponding first output 212, while AI agent 202 relied on a different context slice or record in AI inferencing memory 228 to generate the corresponding output 212.

AI inferencing memory 228 refers to the governed search space accessible to each of the ensemble AI agents. AI inferencing memory 228 may include collections of data sources, indices, embeddings, and context stores from which evidence can be retrieved, filtered, and injected into active context. AI inferencing memory 228 can include live or historical data (e.g., document repositories, logs, telemetry, sensor archives), vector indices and metadata catalogs. Constraints may scope which memory or rank memory importance for a given model, guiding which memory each AI model refers to and relies upon to make an inference. Constraints can expand or narrow AI inferencing memory, adjust evidence windows, etc. The system can capture and store metadata for a given output, indicating which memory entries were relied upon.

Responsive to detecting a deadlock condition, the system initializes a counter AI agent 220. This counter AI agent 220 is configured to operate under a counter-constraint set 222 that is different from the respective constraint applied to at least one of the original ensemble agents. The counter-constraint set 222 can be derived from one or more of the original ensemble AI agents. For example, the counter-constraint set 222 can be an inverted version of one of constraint set 204, constraint set 208, or constraint set 216. Additionally, or alternatively, the counter-constraint set 222 can include a broadened or narrowed constraint of one of the 204, 208, or constraint set 216. More generally, the counter-constraint set 222 can introduce a structured, orthogonal perspective compared to the ensemble AI agents. If the system does not detect a deadlock condition, then the system continues to process the input data with the original ensemble agents, and draw on their outputs. A counter AI agent is not initialized nor is one applied when the deadlock condition is not detected. As described in other sections, in some embodiments, the counter AI agent is initialized by activating alternative inference pathways of an existing one of the ensemble AI agents, rather than instantiating a new counter AI agent. The activated alternative inference pathways of the modified AI agent changes that AI agent to serve as the counter AI agent, introducing structured orthogonal divergence into the reasoning space. Output of this modified AI agent is treated in the same way as the output of an instantiated counter AI agent, subject to the same arbitration and synthesis mechanisms. In an embodiment, the alternative inference pathways are reversible and ephemeral. The system can revert the modified AI agent and its activation parameters back to the prior values, upon completion of arbitration (e.g., based on a TTL or other trigger).

The system processes the input data 210 with the counter AI agent 220 to produce a second output 232. This second output 232 expresses a constraint-defined divergent perspective and includes an indication to modify the operation of the original ensemble. The indication can include explicit or implicit human-readable or machine-readable data that identifies which operating parameters to perturb and/or a direction of change, such as expanding or narrowing retrieval scope within the AI inferencing memory, shifting the evidence window toward different time ranges or salience bands, adjusting inference configuration (e.g., decoding or sampling settings), or temporarily inverting, broadening, or narrowing one or more constraints. In some embodiments, the indication may specify weights (for similarity/divergence, modality emphasis, or domain alignment), or indicate inclusion of specified memory slices or data sources, or attach control-layer tags that guides the ensemble modification block 230.

At ensemble modification block 230, the system modifies at least one of the original ensemble agents in accordance with the indication of the second output 232. Modifications can include a change in retrieval scope, evidence windows, inference configuration, or constraints in any one of the constraint sets of the original ensemble. The retrieval scope may refer to the span of data and/or sources of data in AI inferencing memory 228 that is made available for inference for a particular AI agent, to produce an output. Evidence window may refer to a range of data that may be injected into an agent's active context for a given pass-such as selected documents, passages, frames, or sensor readings-bounded by size, recency, salience, or other gating parameters. Inference configuration may include generation-time settings and pathways, decoding strategy, sampling regime, prompt or template selection, or routing among sub-experts, that determine how the model produces an output under otherwise fixed weights. The system performs the modification while keeping intact the underlying machine learning model (e.g., without retraining the model or otherwise changing the models internal parameters).

At re-processing block 234, the system processes the input data 210 with the modified original ensemble (e.g., with updated constraint set, retrieval scope, evidence window, inference configuration, etc.) to obtain a plurality of updated first outputs. These updated outputs reflect broadened or rebalanced inference.

At synthesize ensemble outputs block 236, the computer system synthesizes the plurality of updated first outputs to generate a final output 240. In an embodiment, the computer system 200 can select a single best-fit output (e.g., when one or more scores of one output exceed others by a threshold) or combine multiple outputs into a composite output. The system may perform a weighted combination of the outputs, where the weights may be determined based on various factors such as confidence, domain alignment with the input data 210, constraints, similarity or divergence signals derived from the deadlock analysis, or other factors. Provenance and arbitration metadata can be recorded, including contributing agents, active constraints or control-layer identifiers, and the decision weights or thresholds used during synthesis. With this deadlock detection and subsequent informed perturbation, the system penalizes excessive similarity and/or incoherent divergence in output among the ensemble AI agents. The arbitration rewards outputs that resolve the deadlock, as opposed to simply selecting one or more outputs through a voting mechanism, a maximization algorithm or agreement, or a best answer (e.g., according to a confidence score or other score). In an embodiment, agreement or disagreement among the outputs of the ensemble AI agents alone is not sufficient to overcome the deadlock condition, nor is the most popular output sufficient to exit deadlock. In an embodiment, the outputs must satisfy both the similarity and divergence criterion, which the system checks for and evaluates in order to exit the deadlock condition.

In an embodiment, evaluating premature convergence includes comparing the plurality of first outputs 212 to determine that differences among the first outputs are less than a similarity threshold. The similarity threshold can be defined using an embedding similarity threshold, a tone-vector similarity threshold, or a similarity in memory reliance computed from AI inferencing memory 228. Additionally, or alternatively, evaluating contradiction includes comparing the plurality of first outputs 212 to determine that differences among the first outputs exceed a difference threshold. The difference threshold can be defined using an embedding difference threshold, a tone-vector difference threshold, a divergence in memory reliance, detection of a domain inconsistency, or identification of mutually exclusive reasoning traces across agents.

In an embodiment, modifying an AI agent based on the second output 232 includes one or more of expanding the retrieval scope, widening or shifting an evidence window, changing an inference configuration, or applying a temporary adjustment to the respective constraints of one or more original agents.

In an embodiment, the counter AI agent 220 is configured to operate with an expanded search space in AI inferencing memory 228, relative to one or more of the original ensemble agents. By doing so, the second output 232 may reflect exploration of a broader or alternative viewpoint. The expanded search space may broaden a temporal window, sensor suite, or database partition that is relied upon for inferencing. In an embodiment, the counter-constraint set 222 is generated by inverting, broadening, or narrowing at least one constraint used by an original ensemble agent so as to form a governed, orthogonal perspective during regeneration under the control layer.

In an embodiment, the counter AI agent 220 is instantiated with a time-to-live corresponding to an arbitration period for production of the final output 240. The system releases the counter AI agent 220 upon expiration of the time-to-live. The system also restores each of the modified AI agents to their original or pre-modification state. In an embodiment, the counter-AI agent is categorized and selected based on the observed similarity and/or divergence pattern of the plurality of first outputs 212.

In an embodiment, the counter AI agent 220 is an identified pathway in one of the original AI agents 214. For example, rather than instantiating a different AI agent, the computer system 200 can activate a pre-known path or paths (e.g., neural paths) in one of the ensemble AI agents, and deactivate the others. The system can enforce extreme weight sparsity in a neural network of the ensemble AI agent to create smaller computational pathways responsible for specific behaviors, making that neural network act in a desired manner (e.g., a divergent manner). In an embodiment, the system may access and select a desired sparse circuit from a plurality of identified, cataloged, and stored sparse circuits, which may each be categorized and selected based on a similarity or divergence pattern.

In an embodiment, the system may check for a deadlock condition with the updated first outputs 238, and continue to modify the ensemble through one or more additional iterations, until the deadlock condition is resolved.

In an embodiment, synthesizing the final output 240 includes selecting from or combining the plurality of updated first outputs and the second output 232 according to constraint compliance, alignment, decision thresholds, and recorded arbitration weights, while maintaining traceability to contributing agents and their active constraints or control layers.

Computer system 200 can detect and resolve deadlock conditions in a variety of applications and contexts. The manner in which the ensemble AI agents are modified, and the type of data that is used as input data 210 and held in AI inferencing memory 228 can vary.

An example of computer system 200 being implemented in a vehicle sensor environment is described below in view of FIG. 2.

In such an example, the input data 210 can include multi-sensor navigation inputs such as camera frames, LiDAR point clouds, and a local map. AI agent 202 operating under constraint set 204 may propose a shortest-path plan, AI agent 206 operating under constraint set 208 may provide obstacle detection and semantic scene understanding, and AI agent 214 operating under constraint set 216 may enforce safety margins and no-go zones. The plurality of first outputs 212 can conflict where the planner asserts a corridor is clear while perception flags an obstacle, producing mutually exclusive reasoning traces and a domain inconsistency that satisfies the divergence criterion 226 in deadlock analysis block 218. A counter AI agent 220 instantiated under a counter-constraint set 222 can be configured to operate with an expanded search space and a safety-first posture, for example requiring an additional sensor sweep and prioritizing obstacle verification. Processing the input with the counter AI agent 220 yields a second output 232 indicating that ensemble modification block 230 should expand retrieval scope of the original AI agent ensemble to include a fresh LiDAR sweep and near-term image frames, adjust the evidence window to emphasize the contested region, and refine an inference configuration to increase detection sensitivity. The re-processing block 234 regenerates updated first outputs under these modified conditions. At synthesize ensemble outputs block 236, the system synthesizes the updated first outputs 238 to produce a governed navigation decision, such as selecting a safe detour that preserves route objectives while satisfying safety constraints.

An example of computer system 200 being implemented as a computer system health monitoring device is described below in view of FIG. 2.

In such an example, input data 210 may comprise service and telemetry logs, performance metrics, and operational events for a distributed system under a readiness assessment. The system processes the input data 210 with an original ensemble of four agents: AI agent 202 operating under constraint 204 synthesizes recent system health summaries; AI agent 206 operating under constraint 208 analyzes error rates, tail latencies, and saturation signals; AI agent 214 operating under constraint 216 evaluates compliance and maintenance posture; and a fourth AI agent operating under a respective constraint focuses on capacity forecasting and change-risk correlation.

At deadlock analysis block 218, the system compares the plurality of first outputs 212 using the similarity criterion 224 and/or the divergence criterion 226. The analysis may consider AI inferencing memory 228 for task context, vector embeddings, and salience signals. The system computes embedding-space similarity, tone-vector similarity, output entropy, and memory reliance patterns. The system identifies premature convergence when all four outputs assert “system healthy” with high embedding similarity, low entropy, and shared memory anchors pointing to the same 24-hour log slice and common dashboards, satisfying the similarity criterion 224. The system also screens for unstructured contradiction by checking domain inconsistency and mutually exclusive reasoning traces under the divergence criterion 226. In this example, contradiction is not dominant, reinforcing a convergence-driven deadlock.

The system generates a counter-perspective by initializing a counter AI agent 220 with a counter-constraint set 222 that is different from at least one original constraint set, biasing its output toward low-salience, long-horizon anomalies and cross-service dependencies. The counter-constraint set 222 inverts narrow recency data biases, broadens temporal coverage, and narrows acceptance thresholds for intermittent faults. The system processes the input data 210 with the counter AI agent 220 to produce a second output 232 that presents a constraint-defined divergent assessment and includes an indication to modify the operation of the original ensemble. The indication identifies operating parameters and directions of change, such as expanding retrieval scope to a 90-day horizon, shifting the evidence window to emphasize low-salience incidents and post-maintenance intervals, adjusting inference configuration toward anomaly-focused decoding and template selection, and temporarily tightening constraints on health claims absent cross-service corroboration.

At ensemble modification block 230, the system interprets the second output 232 in view of AI inferencing memory 228 and applies governed updates to the ensemble's operating conditions. The system expands retrieval scope by querying long-horizon logs, historical incident reports, and change calendars. The system shifts evidence windows to inject low-salience but temporally correlated anomalies into active context. The system adjusts inference configuration to increase sensitivity to intermittent error clusters and seasonality, and it applies temporary constraint posture to require corroboration across telemetry and service boundaries before any agent can conclude “healthy.” These updates do not alter base agent definitions.

At the synthesize ensemble outputs block 236, the system reprocesses the input data 210 under the modified operating conditions and obtains a plurality of updated first outputs 238. The four agents now surface a convergent narrative: the health-summary agent identifies recurring, low-frequency spikes post-deployment; the error/latency agent isolates tail-latency bursts correlated with specific microservice versions; the compliance/maintenance agent flags deferred maintenance windows aligned with the anomalies; and the capacity/change-risk agent links workload seasonality with configuration rollouts, quantifying elevated risk for a particular subsystem.

At synthesize ensemble outputs block 236, the system evaluates the updated first outputs 238 to produce a final, governed output. The final output identifies an at-risk subsystem and prescribes remediation steps tied to the implicated microservice and maintenance schedule.

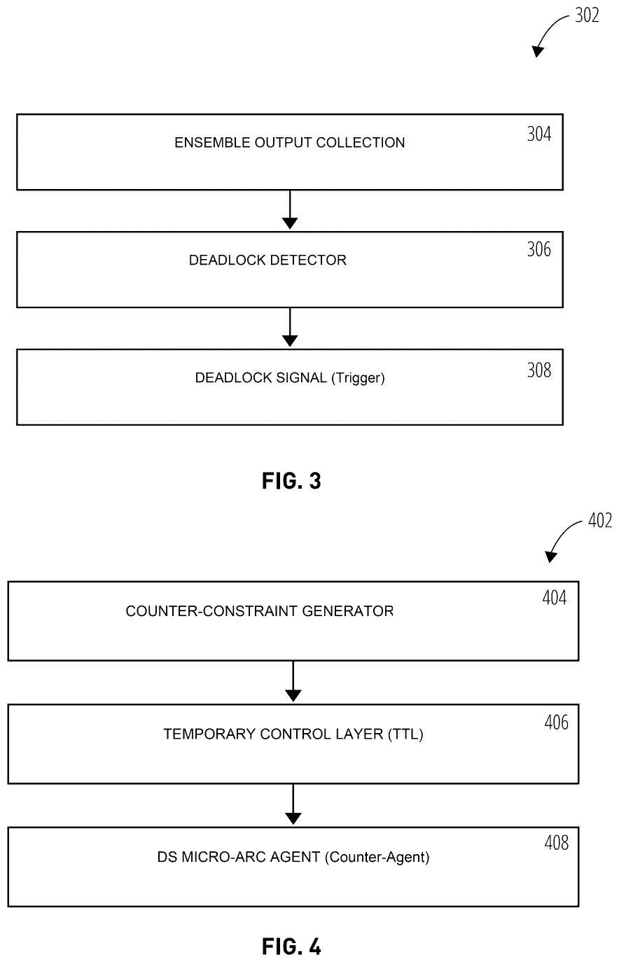

FIG. 3 shows an example workflow for performing AI agent ensemble deadlock detection, in accordance with some embodiments. Workflow 302 may be performed by a computer system or processing logic thereof, that is configured to detect a deadlock among an ensemble of AI agents, as described in other sections.

At ensemble output collection block 304, the system applies an ensemble of AI agents to process input data to generate a plurality of first outputs, respectively. Each of the AI agents may operate under a respective control layer. Each may have a respective constraint set such as domain roles, tool plans, or inference configurations. In this block, the system can obtain the outputs, normalize them, attach metadata, including agent identifiers, constraint tags, retrieval scope, and confidence scores. The system can also prepare analysis features such as embedding vectors, tone vectors, entropy measures, and memory anchors for downstream evaluation.

At deadlock detector block 306, the system compares the outputs from the AI agents to detect a deadlock condition. The outputs may include the normalized outputs and associated metadata from block 304. In an embodiment, the system applies similarity-based and/or divergence-based criterion or criteria to identify the presence of the deadlock condition.

The deadlock condition may comprise a predefined criterion or criteria, capturing similarity and/or divergence deadlock patterns. Similarity analysis may include embedding-space similarity (e.g., cosine similarity), tone-vector proximity, and entropy reduction checks, while divergence analysis may involve detecting domain inconsistencies, incompatible tool plans, or mutually exclusive reasoning traces. Embedding similarity may measure how alike different components of data (text, images, user actions, etc.) are by representing them as numerical vectors, where similar items have vectors that are mathematically close in a high-dimensional space. A divergence-based criterion may include detecting that differences among the first outputs exceed a threshold, such as an embedding-space distance threshold, a tone-vector difference threshold, or a divergence in memory reliance, and may further encompass domain inconsistency or mutually exclusive reasoning traces indicating incompatible premises or conclusions. These metrics may be compared against predefined thresholds, such as a similarity threshold or a difference threshold, to determine whether the ensemble satisfies a deadlock condition.

In response to detecting that the deadlock condition is satisfied, the system proceeds to deadlock signal trigger block 308. The system emits and/or stores a deadlock signal indicating that expanded deliberation is required. This signal may include contextual information such as the detected deadlock type, salient features that triggered the condition, and candidate perturbation parameters (e.g., inverting, broadening, or narrowing constraints; expanding search space; modifying retrieval scope or inference configuration).

The deadlock signal may be routed to a counter-constraint block and micro-arc instantiation pipeline, initializing parameters such as time-to-live (TTL) and arbitration period for subsequent structured divergence and synthesis operations, as described in other sections. This workflow enables real-time detection and resolution of ensemble-level reasoning collapse without modifying underlying model parameters or weights. Models are not retrained, their inferencing is adjusted by adjusting constraints, inferencing memory, or other control parameters.

FIG. 4 illustrates a workflow of a system configured to resolve deadlock among a plurality of artificial intelligence agents by generating and applying structured divergence, in accordance with some embodiments.

Workflow 402 may be initiated in response to a detected deadlock. For example, the system may receive a deadlock signal from the detection workflow described in FIG. 3. This signal includes contextual metadata such as the detected deadlock type signaling a premature convergence or unstructured contradiction, the similarity or divergence thresholds that were triggered, and/or salient features extracted from the ensemble outputs.

At counter-constraint generator block 404, the system constructs a counter-constraint set, which may be based on the type of deadlock condition that is detected (e.g., similarity or divergence), and/or the contextual metadata associated with the deadlock. The counter-constraint set comprises a constraint or combination of constraints that is different from at least one of the original constraints present in the initial ensemble of AI agents. In an embodiment, the counter-constraint set is orthogonal to at least one of the existing agent constraint sets. For example, the system can generate counter-constraints that increase and/or maximize divergence along a select dimension. This dimension can be indicated through the detected deadlock condition. For example, if the deadlock condition is detected as AI agents over-agreeing that an object is detected within input data, then the system may generate counter-constraints to bias the counter-AI agent to detect that an object is not present within the data. In an embodiment, the system may derive the counter-constraints based on the existing agent constraint set. For example, the system may invert a constraint, broaden a constraint to expand the search space or allowable outputs, or narrowing constraint to enforce stricter domain alignment or narrower allowable outputs. The system can also introduce alternative domain perspectives, probabilistically independent sampling conditions, or perturbations to inference configurations. These counter-constraints inject structured divergence into the ensemble's reasoning space without modifying the original agents' parameters, preserving model integrity while increasing perspective diversity. In an embodiment, the system may apply deterministic logic (e.g., non-Stochastic) to ensure that perturbation axes are defined and reproducible for arbitration.

At temporary control layer block 406, the system may generate a temporary control layer, which will be configured to control a counter-AI agent. The temporary control layer may include an ephemeral constraint stack, a constraint set holding one or more counter-constraints. The system may enforce a time-to-live (TTL) parameter corresponding to the arbitration period when the deadlock condition is active. The TTL parameter may comprise a timer or other temporal control mechanism. When the deadlock condition is no longer active, and/or the TTL parameter times out, the system may dispose of the temporary control layer, including counter-AI agent associated with the TTL parameter, and/or other data associated with the counter-AI agent, to reclaim memory allocated to the counter-AI agent.

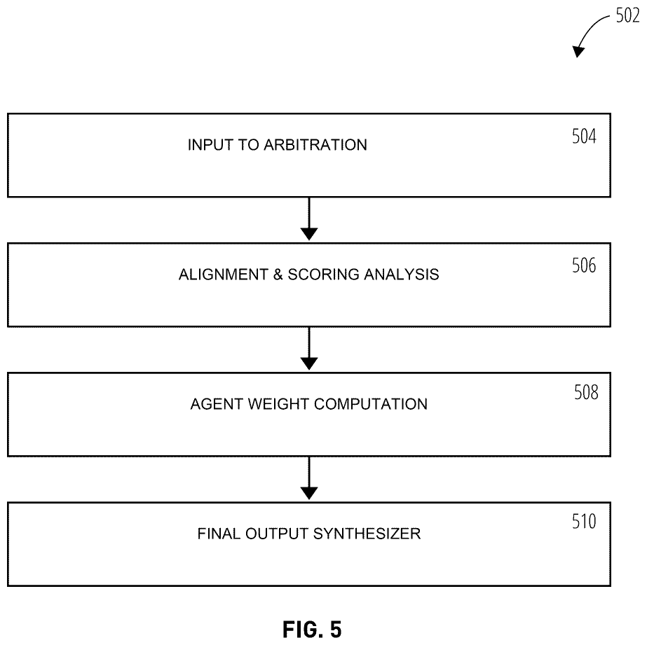

At counter-AI agent block 408, the system instantiates a counter-AI agent under the temporary control layer. In an embodiment, the system may modify one of the existing ensemble agents by setting activation parameters of the AI agent to create a sparse circuits AI agent to serve as the counter-AI agent. In an embodiment, the agent operates with an expanded search space relative to the original ensemble and is configured to produce a structured divergent output. The system may apply the counter-AI agent to the input data, to generate a second output which may include an indication as to how to modify the ensemble (without retraining) to overcome the deadlock condition. The counter-AI agent may employ alternative inference pathways, modified sampling strategies, or orthogonal constraint stacks to generate outputs that restore perspective diversity which may be lost as a result of premature convergence of the original ensemble. Additionally, or alternatively, the structured divergent output may indicate modifications to resolve contradictory outputs from the original ensemble. The output of the counter AI agent may be routed to the arbitration workflow as described in FIG. 5.

FIG. 5 illustrates a flow diagram of a system configured to perform arbitration and synthesis of outputs from a multi-agent ensemble following deadlock resolution, in accordance with some embodiments.

Workflow 502 may be performed by a computer system or processing logic thereof, that is configured to synthesize a plurality of updated outputs from modified ensemble of AI agents, as described in other sections.

At input to arbitration block 504, the system analyzes the second output from the counter-AI agent to extract one or more indications that expressly or implicitly indicate how to modify plurality of AI agents. The system modifies one or more of the ensemble of AI agents accordingly. The modification may include adjustments to retrieval scope, evidence windows, inference configurations, or constraint parameters as indicated by the counter-AI agent's structured divergent output. Other modifications may also be made. The system reprocesses the original input data using the modified ensemble, generating a plurality of updated outputs that reflect the applied modification. These updated outputs, together with any metadata such as confidence scores, constraint tags, and provenance indicators, are staged for arbitration.

At alignment and scoring analysis block 506, the system performs alignment and scoring analysis across the updated outputs. This analysis evaluates coherence, constraint satisfaction, domain relevance, and divergence quality using predefined metrics. The system may compute similarity and/or difference measures in embedding space, tone-vector alignment, and memory salience, while applying penalties for degeneracy or incoherence. Arbitration scoring may also incorporate hierarchical weighting schemes or safety overrides to ensure compliance with task-specific constraints.

In an embodiment, these processes (computing similarity and/or difference measures) involve comparing high-dimensional vector representations of text or other data using metrics such as cosine similarity, Euclidean distance, or orthogonality to determine topical relevance and semantic contrast. Tone-vector alignment and analysis measures response tone by encoding attributes like sentiment, formality, and register into numerical vectors and adjusting outputs through style-transfer or decoding constraints. Memory salience mechanisms can prioritize relevant historical context using attention scores, recency decay, and key-value retrieval, so that the most meaningful past information influences the current response. The system may enforce penalties for degeneracy and incoherence, such as repetition penalties, entropy regularization, and coherence scoring, to refine output quality by suppressing loops, contradictions, and abrupt logical breaks. The system may perform scoring of the outputs. Arbitration scoring may incorporate hierarchical weighting schemes or safety overrides to ensure compliance with task-specific constraints.

At agent weight computation block 508, the system may determine agent weights based on the alignment and scoring analysis. This computation determines the relative influence of each agent's output in the synthesis process, identifying dominant signals, suppressing incoherent contributions, and balancing constraint diversity. Weighted selection or blending strategies are applied to optimize for coherence between outputs and relevance of outputs to the input data, while preserving structured divergence introduced during deadlock resolution.

At final output synthesizer block 510, the system synthesizes a final governed output using the weighed updated outputs, where a higher weighted output has a higher impact in the output than a lower weighted output. The synthesis process may involve combining outputs through blending, selection, or constraint-weighted reconciliation, so that the final result satisfies governing constraints and arbitration criteria. The system may also attach provenance metadata identifying contributing agents and their respective control layers, providing transparency and traceability for downstream operations. In an embodiment, if one output surpasses others by a threshold (e.g., aggregate scoring of domain vectors and confidence vectors), the system selects that single best-fit output. Otherwise, the system synthesizes a composite response by blending or annotating multiple outputs, with constraint-weighted alignment, to form the final governed answer. The system may attach provenance metadata to the final output, identifying a respective contribution of each agent and their originating constraint set or control layer.

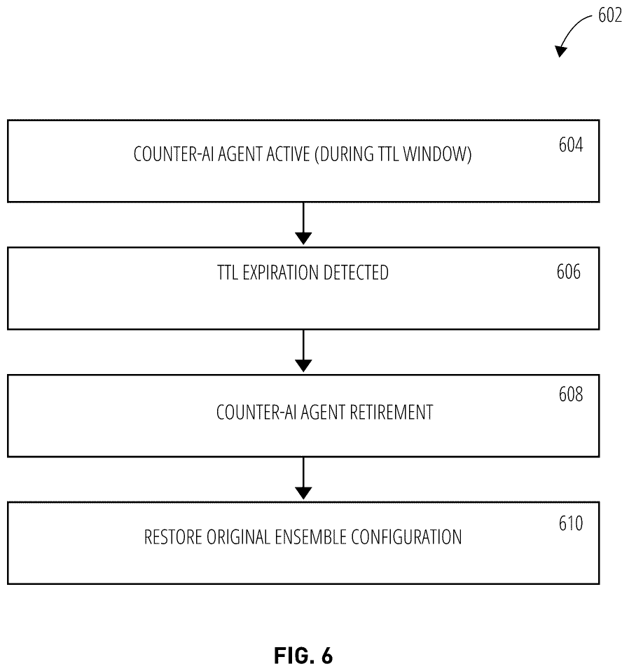

FIG. 6 illustrates a workflow to manage the lifecycle of a counter-AI agent instantiated during deadlock resolution. Workflow 602 may be performed by a computer system or processing logic thereof, that is configured to retire compute resources previously allocated to deadlock resolution, as described in other sections.

At active counter-AI agent block 604, the system maintains an active counter-AI agent operating under a temporary counter-constraint set, which may be generated as part of a temporary control layer. The resources (the counter-AI agent, the counter-constraint set, and/or other resources) may be generated with a TTL parameter. During this active period, the agent influences arbitration and synthesis processes without altering the underlying configuration of the original ensemble, as described.

At TTL expiration detected block 606, the system detects expiration of the TTL parameter. The TTL may correspond to the arbitration period defined during counter-constraint generation and ensures that the counter-AI agent remains active only for the duration necessary to resolve the detected deadlock. The system monitors lifecycle metadata and triggers an expiration event when the TTL threshold is reached, signaling the transition to retirement procedures.

At counter-AI agent retirement block 608, the system retires the counter-AI agent and dismantles the temporary control components such as the counter-constraint set and/or temporary control layer. This process may include removing all ephemeral constraints, terminating any active inference pathways associated with the counter-AI agent. In an embodiment, the system may log metadata related to the retirement event, for auditability and/or automated ensemble re-configuration.

At restore original ensemble configuration block 610, the system restores the original ensemble configuration to its pre-deadlock state. This restoration may include reinstating the original constraint set or any modified AI agents, inference configurations, and/or retrieval scopes associated with the ensemble agents. By reverting to the baseline configuration, the system provides continuity of operation while maintaining the benefits of the resolved deadlock through the synthesized final output. In doing so, the structured divergence is performed as a transient intervention rather than a permanent modification of the ensemble. Accordingly, the system may handle next input data with the original ensemble of AI agents, and repeat the checking for deadlock condition and deadlock handling.

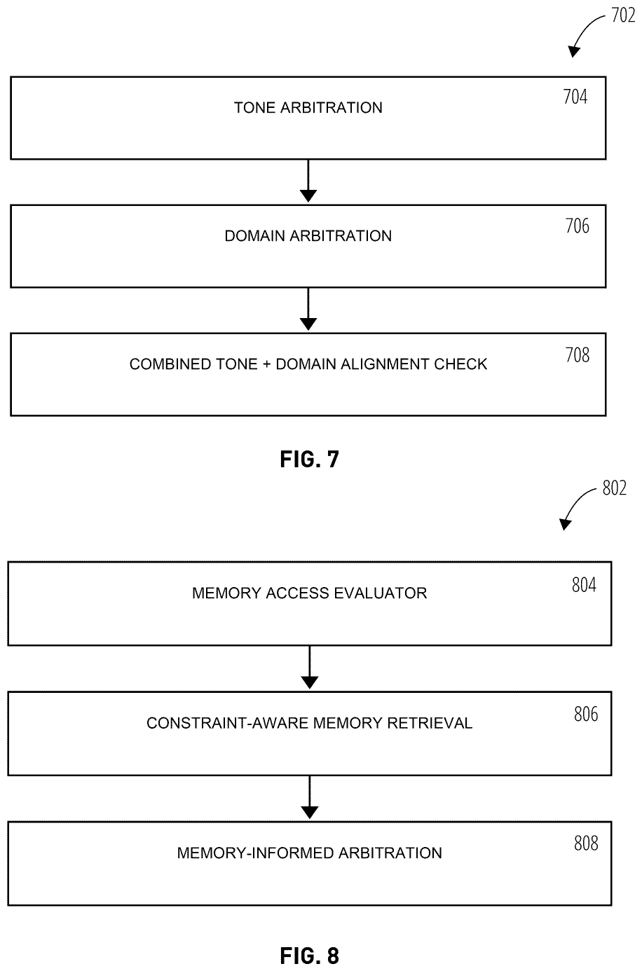

FIG. 7 illustrates a flow diagram of a system configured to perform tone and domain arbitration during synthesis of a governed final output. Workflow 702 may be performed by a computer system or processing logic thereof, that is configured to synthesize a plurality of updated outputs from a plurality AI agents, as described in other sections. Workflow 702 may be performed in combination with workflow 502. In an embodiment, workflow 702 may be a check performed between block 508 and 510. This workflow 702 is an optional embodiment which may be performed after the system introduces divergence into the ensemble AI agents, but prior to final synthesis. This workflow serves as a refinement layer within the larger arbitration and synthesis operations, so that the resolution-enabled outputs satisfy potential one, domain, and/or safety constraints before being merged into the final output.

At tone arbitration block 704, the system evaluates tone characteristics across outputs generated by the ensemble of AI agents. This evaluation may involve computing tone vectors, stylistic similarity measures, and alignment scores to ensure that the synthesized output adheres to predefined tone constraints. The system applies blending or weighting strategies to harmonize stylistic elements while rejecting outputs that exhibit tone incoherence or violate task-specific tone requirements. This process ensures that the final output maintains consistency with the intended communication style or regulatory tone guidelines.

At domain arbitration block 706, the system performs domain arbitration to verify that the outputs comply with domain-specific constraints such as legal, financial, technical, or safety requirements. The system applies domain alignment checks using semantic analysis, constraint-based validation, and veto logic to suppress outputs that fall outside the permissible domain arc. This arbitration step ensures that the synthesized output remains contextually accurate and compliant with governing standards.

At tone and alignment check block 708, the system conducts a combined tone and alignment check to confirm that the final output satisfies both stylistic and domain constraints. This check integrates tone arbitration results with domain compliance scores, applying hierarchical weighting or override logic where necessary. The system validates that the synthesized output meets all governing requirements before finalization, ensuring that tone and domain alignment are preserved in the delivered result.

FIG. 8 illustrates a flow diagram of a system configured to perform memory-conditioned arbitration during synthesis of a governed final output. Workflow 802 may be performed as part of final output synthesizer block 510, or other corresponding operations, as described in other sections.

At memory access evaluation block 804, the system evaluates memory access permissions and relevance for arbitration. This evaluation may include validating domain and role-based permissions of each AI agent to gate and prevent unauthorized memory segments from being accessed. Domain permissions refer to task-specific or security-based controls that govern which portions of historical or contextual data can be retrieved by a given AI agent. The system may compute salience scores, which quantify the importance or relevance of memory slices to the current task. Salience scoring may use statistical measures, embedding similarity, or attention-weighted relevance models to prioritize memory segments that provide meaningful context for resolving deadlock.

At constraint-aware memory retrieval block 806, the system performs constraint-aware memory retrieval, which means selecting and curating memory slices based on predefined constraints such as domain relevance, temporal scope, and safety requirements. This process may include redacting sensitive or irrelevant data, compressing low-salience memory segments. Constraint-aware retrieval ensures that the arbitration workflow 502 receives memory that is both contextually aligned and compliant with operational rules. This informs the system as to which parts of the AI inferencing memory to expand or narrow on.

At memory-informed arbitration block 808, the system conducts memory-informed arbitration, integrating salience-weighted memory signals into the scoring and synthesis process. Memory-informed arbitration uses retrieved contextual data to influence arbitration outcomes, prioritizing outputs that demonstrate coherence with high-salience historical or domain-specific evidence. This integration may involve applying weighted scoring algorithms that combine agent outputs with memory-derived features such as trend patterns, anomaly markers, or constraint compliance indicators. The system may log memory usage metadata for transparency and explanation, enabling traceability of arbitration decisions.

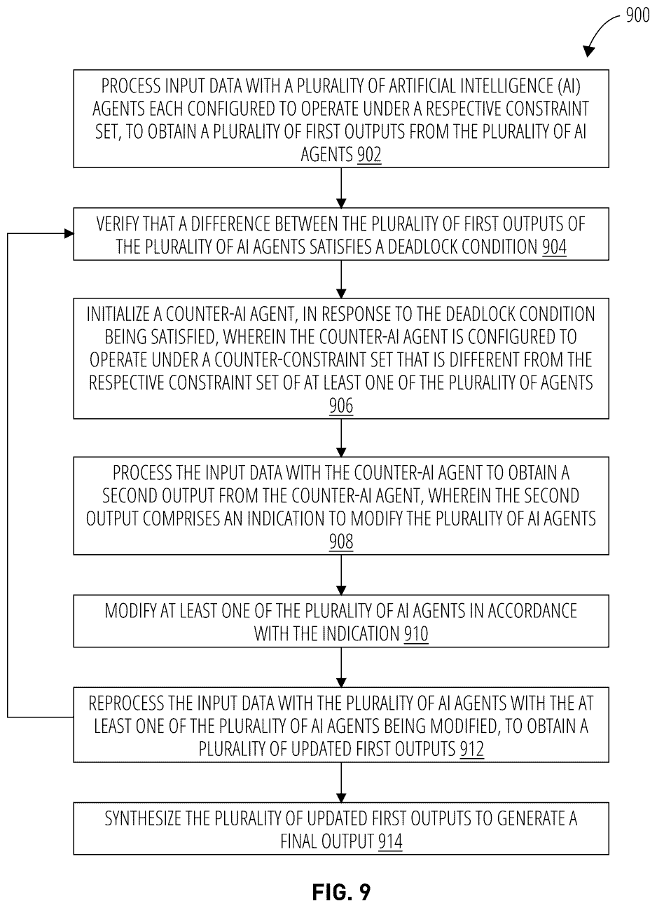

FIG. 9 shows an example method for detecting and resolving a deadlock in a plurality of AI agents, in accordance with some embodiments.

Method 900 may be performed by a computer system or processing logic thereof, that is configured to instantiate, deploy, and manage one or more agents, such as described in other sections. Processing logic may include an application, an operating system, a service, a subroutine, embedded instructions or a script, an agent that is governed by a control layer, or a combination thereof. It should be understood that actions described as being performed by processing logic or a computer system throughout the present disclosure, may be interpreted as being performed by the agent, or a service or routine executing separate from the agent, or a combination thereof.

At block 902, processing logic processes input data with a plurality of artificial intelligence (AI) agents each configured to operate under a respective constraint set, to obtain a plurality of first outputs from the plurality of AI agents. Input data may vary depending on application, as described in other sections.

At block 904, processing logic verifies that a difference between the plurality of first outputs of the plurality of AI agents satisfies a deadlock condition.

In an embodiment, verifying that the difference between the plurality of first outputs satisfies the deadlock condition comprises comparing the plurality of first outputs to each other to determine that the difference is less than a similarity threshold. In an embodiment, the similarity threshold defines at least one of: an embedding similarity threshold, a tonal vector similarity threshold, or a similarity in memory reliance.

In an embodiment, verifying that the difference between the plurality of first outputs satisfies the deadlock condition comprises comparing the plurality of first outputs to each other to determine that the difference is greater than a difference threshold. In an embodiment, the difference threshold defines at least one of: an embedding difference threshold, a tonal vector difference threshold, a divergence in memory reliance, a domain inconsistency, or a mutually exclusive reasoning trace.

At block 906, processing logic initializes a counter-AI agent, in response to the deadlock condition being satisfied, wherein the counter-AI agent is configured to operate under a counter-constraint set that is different from the respective constraint set of at least one of the plurality of agents.

In an embodiment, initializing the counter-AI agent comprises instantiating a new counter-AI agent. In an embodiment, the counter-AI agent is initialized by activating a dedicated and identified set of alternate inferencing pathways of one of the plurality of AI agents, and the counter-constraint set is assigned to the internal neuro pathways. This sparse circuits activation can include deactivating remaining pathways in that model, and activating the identified set (e.g., by setting activation states or weights of connections between artificial neural network nodes, or otherwise biasing the underlying algorithm of a given model) to bias and control the inferencing of the model toward providing a divergent outcome in the desired axis. In an embodiment, the system can take a blended approach. For example, depending on the type of deadlock condition, or the magnitude of the deadlock, the system may decide whether to take a sparse circuits approach to use an existing one of the ensemble AI agents to generate the counter-AI agent, or instantiate a new counter-AI agent. A first round of input data may trigger a deadlock condition in which the sparse circuits approach is taken, and a second input data may trigger a deadlock condition in which a new counter-AI agent is instantiated.

In an embodiment, the counter-AI agent operates under an expanded search space relative to one or more of the plurality of AI agents. Each AI agent may be configured to refer to a search space, and the counter-AI agent may be a derivation (e.g., expanding or narrowing) of the search space of one of the plurality of AI agent.

In an embodiment, the counter-constraint set is generated based on inverting, broadening, or narrowing the respective constraint set of at least one of the plurality of AI agents.

In an embodiment, the counter-AI agent is instantiated with a time-to-live (TTL), the TTL corresponds with an arbitration period of generating the final output, and the counter-AI agent is released upon expiration of the TTL. For example, the instantiated counter-AI agent is released in memory, or in the case of using alternate inferencing pathways, the system can reset the pathways to the pre-modification state. The counter-AI agent and associated control layer and/or counter constraints are transient interventions. Processing logic may detect that the deadlock condition is resolved (e.g., the similarity and/or divergence thresholds are no longer surpassed). In response, processing logic may destroy the counter-AI agent and release system memory and compute resources allocated to that counter-AI agent, including releasing counter-constraints and/or the larger control layer. Similarly, in the case of alternate inferencing pathways, processing logic can reset the pathways of the machine learning model to the prior state.

At block 908, processing logic processes the input data with the counter-AI agent to obtain a second output from the counter-AI agent, wherein the second output comprises an indication to modify the plurality of AI agents.

At block 910, processing logic modifies at least one of the plurality of AI agents in accordance with the indication. In an embodiment, modifying at least one of the plurality of AI agents in accordance with the indication comprises modifying a retrieval scope, an evidence window, an inference configuration, or the respective constraint set of the AI agent.

At block 912, processing logic reprocesses the input data with the plurality of AI agents with the at least one of the plurality of AI agents being modified, to obtain a plurality of updated first outputs. In some embodiments, processing logic may check the plurality of updated first outputs for a deadlock. If found, the system may re-modify the plurality of AI agents using the same counter-AI agent or a different counter-AI agent to guide the modification. The system can repeat this process until the deadlock condition is removed.

At block 914, processing logic synthesizes the plurality of updated first outputs to generate a final output. In an embodiment, synthesizing the plurality of updated first outputs to generate the final output comprises performing a weighted combination of the updated first outputs.

In an embodiment, the disclosed method and system performs the deadlock detection and resolution without retraining, fine-tuning, or updating weights that govern the underlying model algorithm. The system maintains the model parameters in a fixed state, while making non-training changes to the models, such as modifying constraint sets, model retrieval scope, inference configuration, and/or control layers, as described in other sections.

In an embodiment, the method and system stores metadata which may include parameters that store each detected deadlock, the counter constraints, inferencing pathways associated with the counter-AI agent, the adjustments made to the ensemble, arbitration weights assigned to each output of the ensemble, and/or other data indicative of actions taken to detect or resolve the deadlock. The metadata may be stored and serve as an audit trail and/or to validate system compliance.

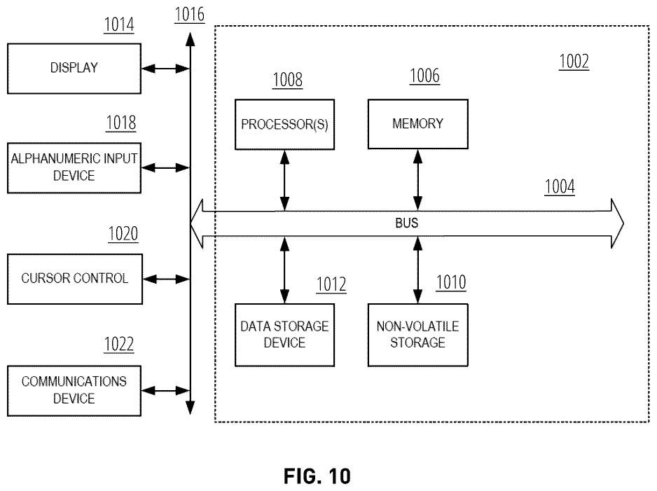

FIG. 10 is one embodiment of a computer system that may be used to support the systems and operations described, in accordance with an embodiment. For example, FIG. 10 may show a computer system and/or processing logic as described in other sections.

The computer system 1002 illustrated in FIG. 10 includes a bus or other internal communication means 1004 for communicating information, and one or more processors 1008 coupled to the bus 1004 for processing information. The system further comprises a random access memory (RAM) or other volatile storage device 1006 (referred to as memory), coupled to bus 1004 for storing information and instructions to be executed by processor 1008. Main memory 1006 also may be used for storing temporary variables or other intermediate information during execution of instructions by processor 1008. The system also comprises a read only memory (ROM), non-volatile storage, and/or static storage device 1010 coupled to bus 1004 for storing static information and instructions for processor 1008, and a data storage device 1012 such as a magnetic disk or optical disk and its corresponding disk drive. Data storage device 1012 is coupled to bus 1004 for storing information and instructions.

The system may further be coupled to a display device 1014, such as a light emitting diode (LED) display or a liquid crystal display (LCD) coupled to bus 1004 through bus 1016 for displaying information to a computer user. An alphanumeric input device 1018, including alphanumeric and other keys, may also be coupled to bus 1004 through bus 1016 for communicating information and command selections to processor 1008. An additional user input device is cursor control device 1020, such as a touchpad, mouse, a trackball, stylus, or cursor direction keys coupled to bus 1004 through bus 1016 for communicating direction information and command selections to processor 1008, and for controlling cursor movement on display device 1014.

Another device, which may optionally be coupled to computer system 1002, is a communication device 1022 for accessing other nodes of a distributed system via a network. The communication device 1022 may include any of a number of commercially available networking peripheral devices such as those used for coupling to an Ethernet, token ring, Internet, or wide area network. The communication device 1022 may further be a null-modem connection, or any other mechanism that provides connectivity between the computer system 1002 and the outside world. Note that any or all of the components of this system illustrated in FIG. 10 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 1006, mass storage device 1012, or other storage medium locally or remotely accessible to processor 1008.

It will be apparent to those of ordinary skill in the art that the system, method, and process described herein can be implemented as software stored in main memory 1006 or read only memory and executed by processor 1008. This control logic or software may also be resident on an article of manufacture comprising a computer readable medium having computer readable program code embodied therein and being readable by the mass storage device 1012 and for causing the processor 1008 to operate in accordance with the methods and teachings herein.

The embodiments discussed herein may also be embodied in a handheld or portable device containing a subset of the computer hardware components described above. For example, the handheld device may be configured to contain only the bus 1004, the processor 1008, and memory 1006 and/or 1012. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 1008, a data storage device 1012, a bus 1004, and memory 1006, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, performed by a computing device, comprising:
processing input data with a plurality of artificial intelligence (AI) agents each configured to operate under a respective constraint set, to obtain a plurality of first outputs from the plurality of AI agents;
verifying that a difference between the plurality of first outputs of the plurality of AI agents satisfies a deadlock condition;
initializing a counter-AI agent, in response to the deadlock condition being satisfied, wherein the counter-AI agent is configured to operate under a counter-constraint set that is different from the respective constraint set of at least one of the plurality of agents;
processing the input data with the counter-AI agent to obtain a second output from the counter-AI agent, wherein the second output comprises an indication to modify the plurality of AI agents;
modifying at least one of the plurality of AI agents in accordance with the indication;
reprocessing the input data with the plurality of AI agents with the at least one of the plurality of AI agents being modified, to obtain a plurality of updated first outputs; and
synthesizing the plurality of updated first outputs to generate a final output.

2. The method of claim 1, wherein verifying that the difference between the plurality of first outputs of the plurality of AI agents satisfies the deadlock condition comprises comparing the plurality of first outputs to each other to determine that the difference between the plurality of first outputs is less than a similarity threshold.

3. The method of claim 2, wherein the similarity threshold defines at least one of: an embedding similarity threshold, a tonal vector similarity threshold, or a similarity in memory reliance.

4. The method of claim 2, wherein verifying that the difference between the plurality of first outputs of the plurality of AI agents satisfies the deadlock condition further comprises comparing the plurality of first outputs to each other to determine that the difference between the plurality of first outputs is greater than a difference threshold.

5. The method of claim 4, wherein the difference threshold defines at least one of: an embedding difference threshold, a tonal vector difference threshold, a divergence in memory reliance, a domain inconsistency, or a mutually exclusive reasoning trace.

6. The method of claim 1, wherein modifying the at least one of the plurality of AI agents in accordance with the indication comprises modifying a retrieval scope, an evidence window, an inference configuration, or the respective constraint set of the at least one of the plurality of AI agents.

7. The method of claim 1, wherein the counter-AI agent is operated under an expanded search space, relative to one or more of the plurality of AI agents.

8. The method of claim 1, wherein the counter-AI agent is instantiated with a time-to-live (TTL), the TTL corresponds with an arbitration period of generating the final output, and the counter-AI agent is released upon expiration of the TTL.

9. The method of claim 1, wherein the counter-constraint set is generated based on inverting, broadening, or narrowing the respective constraint set of at least one of the plurality of AI agents.

10. The method of claim 1, wherein synthesizing the plurality of updated first outputs to generate the final output comprises performing a weighted combination of the updated first outputs to generate the final output.

11. The method of claim 1, wherein initializing the counter-AI agent comprises instantiating a new counter-AI agent.

12. The method of claim 1, wherein the counter-AI agent is an internal neuro pathway of one of the plurality of AI agents, and the counter-constraint set is assigned to the internal neuro pathway.

13. A computing system comprising:
one or more processors; and
a memory storing instructions that, when executed by the one or more processors, configure the system to:
process input data with a plurality of artificial intelligence (AI) agents each configured to operate under a respective constraint set, to obtain a plurality of first outputs from the plurality of AI agents;
verify that a difference between the plurality of first outputs of the plurality of AI agents satisfies a deadlock condition;
initialize a counter-AI agent, in response to the deadlock condition being satisfied, wherein the counter-AI agent is configured to operate under a counter-constraint set that is different from the respective constraint set of at least one of the plurality of agents;
process the input data with the counter-AI agent to obtain a second output from the counter-AI agent, wherein the second output comprises an indication to modify the plurality of AI agents;
modify at least one of the plurality of AI agents in accordance with the indication;
reprocess the input data with the plurality of AI agents with the at least one of the plurality of AI agents being modified, to obtain a plurality of updated first outputs; and
synthesize the plurality of updated first outputs to generate a final output.

14. The computing system of claim 13, wherein to verify that the difference between the plurality of first outputs of the plurality of AI agents satisfies the deadlock condition comprises to compare the plurality of first outputs to each other to determine that the difference between the plurality of first outputs is less than a similarity threshold.

15. The computing system of claim 14, wherein the similarity threshold defines at least one of: an embedding similarity threshold, a tonal vector similarity threshold, or a similarity in memory reliance.

16. The computing system of claim 14, wherein to verify that the difference between the plurality of first outputs of the plurality of AI agents satisfies the deadlock condition further comprises to compare the plurality of first outputs to each other to determine that the difference between the plurality of first outputs is greater than a difference threshold.

17. A non-transitory computer-readable storage medium, the computer-readable storage medium including instructions that when executed by a computer system, causes the computer system to:
process input data with a plurality of artificial intelligence (AI) agents each configured to operate under a respective constraint set, to obtain a plurality of first outputs from the plurality of AI agents;
verify that a difference between the plurality of first outputs of the plurality of AI agents satisfies a deadlock condition;
initialize a counter-AI agent, in response to the deadlock condition being satisfied, wherein the counter-AI agent is configured to operate under a counter-constraint set that is different from the respective constraint set of at least one of the plurality of agents;
process the input data with the counter-AI agent to obtain a second output from the counter-AI agent, wherein the second output comprises an indication to modify the plurality of AI agents;
modify at least one of the plurality of AI agents in accordance with the indication;
reprocess the input data with the plurality of AI agents with the at least one of the plurality of AI agents being modified, to obtain a plurality of updated first outputs; and
synthesize the plurality of updated first outputs to generate a final output.

18. The computer-readable storage medium of claim 17, wherein to verify that the difference between the plurality of first outputs of the plurality of AI agents satisfies the deadlock condition comprises to compare the plurality of first outputs to each other to determine that the difference between the plurality of first outputs is less than a similarity threshold.

19. The computer-readable storage medium of claim 18, wherein the similarity threshold defines at least one of: an embedding similarity threshold, a tonal vector similarity threshold, or a similarity in memory reliance.

20. The computer-readable storage medium of claim 18, wherein to verify that the difference between the plurality of first outputs of the plurality of AI agents satisfies the deadlock condition further comprises to compare the plurality of first outputs to each other to determine that the difference between the plurality of first outputs is greater than a difference threshold.
